(19) United States
(12) Patent Application Publication
(10) Pub. No.: US 2021/0324119 A1
(43) Pub. Date: Oct. 21, 2021

(54) POLYPROPYLENE COMPOSITION FOR MELT SPUN FIBER APPLICATIONS

(71) Applicant: BOREALIS AG, Vienna (AT)

(72) Inventors: Henk Van Paridon, Averbode (BE); Bert Broeders, Beringen (BE)

(21) Appl. No.: 17/268,110

(22) PCT Filed: Sep. 20, 2019
(86) PCT No.: PCT/EP2019/075290

§ 371 Date: Feb. 12, 2021

(30) Foreign Application Priority Data
Sep. 21, 2018 (EP) 18195978.4

(51) Int. Cl. C08F 210/06; D04H 3/007; D04H 3/16; D01F 6/30; D01D 5/08

(52) U.S. Cl. CPC C08F 210/06; D04H 3/007; C08F 2800/20; D01F 6/30; D01D 5/08; D04H 3/16

(57) ABSTRACT

The present invention relates to a melt spun fiber comprising a propylene polymer composition comprising a terpolymer of propylene with ethylene comonomer units and alpha-olefin comonomer units having from 4 to 12 carbon atoms, wherein the propylene polymer composition has a melt flow rate MFR (230° C., 2.16 kg) of from 10 to 200 g/10 min and a melting temperature of less than 153° C., a spunbonded nonwoven fabric comprising the melt spun fibers, a process for producing said spunbonded nonwoven fabric, an article comprising said melt spun fiber and/or spunbonded nonwoven fabric, and the use of said terpolymer of propylene with ethylene comonomer units and alpha-olefin comonomer units having from 4 to 12 carbon atoms for increasing the spinnability of melt spun fibers and the mechanical properties of spunbonded nonwoven fabrics.

### FIELD OF THE INVENTION

The present invention relates to melt spun fibers (monocomponent/bicomponent) comprising a terpolymer of propylene with ethylene comonomer units and alpha-olefin comonomer units having from 4 to 12 carbon atoms, a spunbonded nonwoven fabric comprising said melt spun fibers, a process for preparing said spunbonded nonwoven fabric and an article comprising said melt spun fibers or spunbonded nonwoven fabric.

### BACKGROUND OF THE INVENTION

Today, polypropylene fibers or polypropylene nonwoven fabrics have been used in a variety of applications, including filtration medium (filter), diapers, sanitary products, sanitary napkin, panty liner, incontinence product for adults, protective clothing materials, bandages, surgical drape, surgical gown, surgical wear and packing materials.

In general, for production of a spunbonded nonwoven fabric, important points are flowability of the raw material during a spinning process, drawability of the formed filaments without breakage, fibre bonding quality in the fabric as well as the overall stability of the spinning process.

A further important point is that polymers used in the production of spunbonded nonwoven fabrics and laminates thereof should exhibit good tensile properties over a broad range of processing conditions, since such spunbonded nonwoven fabrics are i.a. characterized by tensile strength and elongation at break.

Currently it is believed that for obtaining spunbonded nonwoven fabrics with good mechanical properties such as tensile strength and elongation at break propylene polymer should be used which have a sufficient crystallinity showing a high melting temperature.

WO 2004/029342 A1 discloses spunbonded nonwoven fabrics made from fibers comprising a propylene homo- or copolymer composition (A) having a melting temperature of at least 153° C.

WO 2017/118612 A1 discloses spunbonded nonwoven fabrics made from fibers comprising a propylene homopolymer composition having a melting temperature of at least 150° C.

Despite the progress in mechanical properties over the recent years, there remains a constant demand for further improvement to allow further output increases and finer fibres e.g. to facilitate down gaging or softness. In this respect improved spinning process stability and improved tensile strength and elongation at break are highly desirable for both fibre based fabrics and spunbonded nonwoven fabrics.

In view of the foregoing, an object of the present invention is to provide a polypropylene based spunbonded nonwoven fabric having a superior combination of mechanical and physical properties together with good processability.

In the present invention it has surprisingly been found that melt spun fibers comprising polypropylene composition having a low melting temperature of less than 153° C., which comprises a terpolymer of propylene with ethylene comonomer units and alpha-olefin comonomer units having from 4 to 12 carbon atoms, show an improved balance of properties of excellent spinning properties together with good mechanical properties and low bonding temperature.

### SUMMARY OF THE INVENTION

The present invention relates to a melt spun fiber comprising a propylene polymer composition comprising a terpolymer of propylene with ethylene comonomer units and alpha-olefin comonomer units having from 4 to 12 carbon atoms, wherein the propylene polymer composition has a melt flow rate MFR (230° C., 2.16 kg) of from 10 to 200 g/10 min and a melting temperature of less than 153° C.

The present invention further relates to a spunbonded nonwoven fabric comprising the melt spun fibers as defined above or below.

Still further, the present invention relates to process for preparing a spunbonded nonwoven fabric as defined above or below comprising the steps of

providing a propylene polymer composition comprising a terpolymer of propylene with ethylene comonomer units and alpha-olefin comonomer units having from 4 to 12 carbon atoms, which has a melt flow rate MFR (230° C., 2.16 kg) of from 10 to 200 g/10 min and a melting temperature of less than 153° C.; and

spunbonding said propylene polymer composition by using a fiber spinning line at a maximum cabin air pressure of from 3,000 Pa to 10,000 Pa.

Additionally, the present invention relates to an articles comprising the melt spun fiber or spunbonded nonwoven fabric as defined above or below.

Further, the present invention relates to the use of a terpolymer of propylene with ethylene comonomer units and alpha-olefin comonomer units having from 4 to 12 carbon atoms in a propylene polymer composition having a melt flow rate MFR (230° C., 2.16 kg) of from 10 to 200 g/10 min and a melting temperature of less than 153° C. for increasing the spinnability of melt spun fibers.

Still further, the present invention relates to the use of a terpolymer of propylene with ethylene comonomer units and alpha-olefin comonomer units having from 4 to 12 carbon atoms in a propylene polymer composition having a melt flow rate MFR (230° C., 2.16 kg) of from 10 to 200 g/10 min and a melting temperature of less than 153° C. for increasing the mechanical properties of spunbonded nonwoven fabrics.

### Definitions

A propylene random copolymer is a copolymer of propylene monomer units and comonomer units in which the comonomer units are distributed randomly over the polypropylene chain. Thereby, a propylene random copolymer includes a fraction, which is insoluble in xylene—xylene cold insoluble (XCU) fraction—in an amount of at least 70 wt %, more preferably of at least 80 wt %, still more preferably of at least 85 wt %, most preferably of at least 88 wt %, based on the total amount of propylene random copolymer. Accordingly, the propylene random copolymer does not contain an elastomeric polymer phase dispersed therein.

A propylene random terpolymer is a specific form of a propylene random copolymer in which two different comonomer units, such as e.g. ethylene and 1-butene comonomer units, are distributed randomly over the polypropylene chain.

A propylene homopolymer is a polymer which essentially consists of propylene monomer units. Due to impurities especially during commercial polymerization processes a propylene homopolymer can comprise up to 0.1 mol % comonomer units, preferably up to 0.05 mol % comonomer units and most preferably up to 0.01 mol % comonomer units.

In the following, amounts are given as % by weight (wt %) unless it is stated otherwise.

### FIGURES

FIG. 1 shows a comparison of the tenacity behavior of the fibers of the inventive example IE1 and of the comparative example CE2 over a take-up speed range from the starting take-up speed to their maximum take-up speeds.

FIG. 2 shows a comparison of the elongation of the fibers of the inventive example IE1 and of the comparative example CE2 over a take-up speed range from the starting take-up speed to their maximum take-up speeds.

### DETAILED DESCRIPTION

The present invention relates to a melt spun fiber comprising a propylene polymer composition comprising a terpolymer of propylene with ethylene comonomer units and alpha-olefin comonomer units having from 4 to 12 carbon atoms, wherein the propylene polymer composition has a melt flow rate MFR (230° C., 2.16 kg) of from 10 to 200 g/10 min and a melting temperature of less than 153° C.

Terpolymer of Propylene with Ethylene Comonomer Units and Alpha-Olefin Comonomer Units Having from 4 to 12 Carbon Atoms

In the following the terpolymer of propylene with ethylene comonomer units and alpha-olefin comonomer units is abbreviated terpolymer of propylene.

The terpolymer of propylene comprises ethylene comonomer units and alpha-olefin comonomer units having from 4 to 12 carbon atoms.

Preferably, the alpha-olefin comonomer units having from 4 to 12 carbon atoms are selected from 1-butene, 1-hexene or 1-octene, more preferably from 1-butene or 1-hexene and most preferably from 1-butene.

Preferably the terpolymer of propylene is a propylene/ethylene/1-butene terpolymer.

The terpolymer of propylene preferably has a total amount of comonomer units of from 2.3 wt % to 15.0 wt %, more preferably from 3.5 wt % to 12.5 wt %, still more preferably from 5.0 wt % to 10.0 wt % and most preferably from 7.5 wt % to 9.0 wt %, based on the total weight of the terpolymer of propylene.

The terpolymer of propylene preferably has a total amount of ethylene comonomer units of from 0.3 wt % to 5.0 wt %, more preferably from 0.7 wt % to 4.0 wt %, still more preferably from 1.0 wt % to 3.0 wt % and most preferably from 1.5 wt % to 2.5 wt %, based on the total weight of the terpolymer of propylene.

The terpolymer of propylene preferably has a total amount of alpha-olefin comonomer units having from 4 to 12 carbon atoms of from 2.0 wt % to 10.0 wt %, more preferably from 3.5 wt % to 9.0 wt %, still more preferably from 5.0 wt % to 8.0 wt % and most preferably from 6.0 wt % to 7.5 wt %, based on the total weight of the terpolymer of propylene.

Preferably, the weight amount of ethylene comonomer units in the terpolymer of propylene in lower than the weight amount of alpha-olefin comonomer units having from 4 to 12 carbon atoms. It is appreciated that the weight ratio of ethylene comonomer units (C2) to alpha olefin comonomer units having from 4 to 12 carbon atoms (C4-12) [C2/C4-12] is in the range of 1/100 to below 1/1, more preferably in the range of 1/10 to 1/2, still more preferably in the range of 1/6 to 1/2.5 and most preferably in the range of 1/5.5 to 1/3.

The terpolymer of propylene preferably is a random terpolymer of propylene, more preferably a random propylene/ethylene/1-butene terpolymer.

The terpolymer of propylene can be polymerized in a single stage polymerization process in one reactor or in a multistage polymerization process in two or more reactors arranged in a sequential order.

In a one stage polymerization process all monomer and comonomer units are introduced into the single polymerization reactor.

Suitably, the single polymerization reactor is selected from slurry phase reactors such as a continuous or simple stirred batch tank reactor or loop reactor operating in bulk or slurry, solution reactors and gas phase reactors. The polymerization conditions are adapted to the accordant reactor type as to produce the terpolymer of propylene as described above or below.

In a multistage polymerization process the terpolymer of propylene is produced in at least two reactors connected in series. Accordingly, the polymerization system for sequential polymerization comprises at least a first polymerization reactor and a second polymerization reactor, and optionally a third polymerization reactor. The term “polymerization reactor” shall indicate that the main polymerization takes place. Thus, in case the process consists of two polymerization reactors, this definition does not exclude the option that the overall system comprises for instance a pre-polymerization step in a prepolymerization reactor. The term “consist of” is only a closing formulation in view of the main polymerization reactors.

Preferably the first polymerization reactor is, in any case, a slurry phase reactor and can be any continuous or simple stirred batch tank reactor or loop reactor operating in bulk or slurry. Bulk means a polymerization in a reaction medium that comprises of at least 60% (w/w) monomer. According to the present invention the slurry reactor is preferably a (bulk) loop reactor.

The optional second polymerization reactor can be either a slurry reactor, as defined above, preferably a loop reactor or a gas phase reactor.

The optional third polymerization reactor is preferably a gas phase reactor.

Suitable sequential polymerization processes are known in the state of the art.

A preferred multistage process is a “loop-gas phase”-process, such as developed by Borealis (known as BORSTAR® technology) described e.g. in patent literature, such as in EP 0 887 379, WO 92/12182 WO 2004/000899, WO 2004/111095, WO 99/24478, WO 99/24479 or in WO 00/68315.

A further suitable slurry-gas phase process is the Spheripol® process of Basell.

In one embodiment of the multistage polymerization process in the first polymerization stage a copolymer of propylene and ethylene is polymerized and in the second polymerization stage a copolymer of propylene and alpha-olefin comonomer units having from 4 to 12 carbon atoms is polymerized.

In another embodiment of the multistage polymerization process in the first polymerization stage a copolymer of propylene and alpha-olefin comonomer units having from 4 to 12 carbon atoms is polymerized and in the second polymerization stage a copolymer of propylene and ethylene is polymerized.

In still another embodiment of the multistage polymerization process in both polymerization stages a terpolymer of propylene with ethylene and alpha-olefin comonomer units having from 4 to 12 carbon atoms is polymerized.

In yet another embodiment of the multistage polymerization process in the first polymerization stage a propylene homopolymer is polymerized and in the second polymerization stage a terpolymer of propylene with ethylene and alpha-olefin comonomer units having from 4 to 12 carbon atoms is polymerized.

All above embodiments are equally suitable for producing the terpolymer of propylene with ethylene and alpha-olefin comonomer units having from 4 to 12 carbon atoms as defined above or below.

It is within the skill of art skilled persons to choose the polymerization conditions in a way to yield the desired properties of the terpolymer of propylene as described above or below.

The terpolymer of propylene is preferably polymerized in the presence of a coordination catalyst. Preferably, the terpolymer of propylene is polymerized using a Ziegler-Natta catalyst, in particular a high yield Ziegler-Natta catalyst (so-called fourth and fifth generation type to differentiate from low yield, so called second generation Ziegler-Natta catalysts). A suitable Ziegler-Natta catalyst to be employed in accordance with the present invention comprises a catalyst component, a co-catalyst component and at least one electron donor (internal and/or external electron donor, preferably at least one external donor). Preferably, the catalyst component is a Ti—Mg-based catalyst component and typically the co-catalyst is an Al-alkyl based compound. Suitable catalysts are in particular disclosed in U.S. Pat. No. 5,234,879, WO 92/19653, WO 92/19658 and WO 99/33843.

Preferred external donors are the known silane-based donors, such as dicyclopentyl dimethoxy silane or cyclohexyl methyldimethoxy silane.

### Propylene Polymer Composition

The propylene polymer composition preferably comprises the terpolymer of propylene in an amount of at least 90 wt %, more preferably of at least 93 wt %, still more preferably of at least 95 wt % and most preferably of at least 97 wt %.

The propylene polymer composition can further comprise additionally small amounts of additives selected from the group comprising antioxidants, stabilizers, fillers, colorants, nucleating agents and antistatic agents in amounts of not more than 10 wt %, more preferably of not more than 7 wt %, still more preferably of not more than 5 wt % and most preferably of not more than 3 wt %. In general, they are incorporated during granulation of the pulverulent product obtained in the polymerization.

The additives can be added to the propylene polymer composition in form of masterbatches. These masterbatches usually include small amounts of polymers. These polymers of the masterbatches are not counted to other polymeric components but to the amount of additives in the propylene polymer composition.

The propylene polymer composition may also include small amounts of other polymer components different from the terpolymer of propylene.

However, it is preferred that the terpolymer of propylene is the only polymeric component in the propylene polymer composition.

The propylene polymer composition has a melt flow rate MFR₂ (230° C., 2.16 kg) of from 10 to 200 g/10 min, preferably of from 13 to 150 g/10 min, still more preferably of from 15 to 100 g/10 min and most preferably of from 20 to 50 g/10 min.

Preferably, the melt flow rate is obtained by subjecting the propylene polymer composition to a visbreaking step.

Preferred mixing devices suited for visbreaking are known to an art skilled person and can be selected i.a. from discontinuous and continuous kneaders, twin screw extruders and single screw extruders with special mixing sections and co-kneaders and the like.

The visbreaking step according to the present invention is performed either with a peroxide or mixture of peroxides or with a hydroxylamine ester or a mercaptane compound as source of free radicals (visbreaking agent) or by purely thermal degradation.

Typical peroxides being suitable as visbreaking agents are 2,5-dimethyl-2,5-bis(tert.butylperoxy)hexane (DHBP) (for instance sold under the tradenames Luperox 101 and Trigonox 101), 2,5-dimethyl-2,5-bis(tert.butyl-peroxy)hexyne-3 (DYBP) (for instance sold under the tradenames Luperox 130 and Trigonox 145), dicumyl-peroxide (DCUP) (for instance sold under the tradenames Luperox DC and Perkadox BC), di-tert.butyl-peroxide (DTBP) (for instance sold under the tradenames Trigonox B and Luperox Di), tert.butyl-cumyl-peroxide (BCUP) (for instance sold under the tradenames Trigonox T and Luperox 801) and bis(tert.butylperoxy-isopropyl)benzene (DIPP) (for instance sold under the tradenames Perkadox 14S and Luperox DC).

Suitable amounts of peroxide to be employed in accordance with the present invention are in principle known to the skilled person and can easily be calculated on the basis of the amount of propylene homopolymer to be subjected to visbreaking, the MFR₂ (230° C.) value of the propylene homopolymer to be subjected to visbreaking and the desired target MFR₂ (230° C.) of the product to be obtained.

Accordingly, typical amounts of peroxide visbreaking agent are from 0.005 to 0.5 wt %, more preferably from 0.01 to 0.2 wt %, based on the total amount of polypropylene homopolymer employed. Typically, visbreaking in accordance with the present invention is carried out in an extruder, so that under the suitable conditions, an increase of melt flow rate is obtained. During visbreaking, higher molar mass chains of the starting product are broken statistically more frequently than lower molar mass molecules, resulting as indicated above in an overall decrease of the average molecular weight and an increase in melt flow rate.

After visbreaking the polypropylene terpolymer of propylene is preferably in the form of pellets or granules. The instant terpolymer of propylene is preferably used in pellet or granule form for the melt spinning process and the spunbonded fiber process.

The propylene polymer composition further has a melting temperature measured according to ISO 11357-3 of less than 153° C., preferably in the range of from 120° C. to 150° C., more preferably in the range of from 125° C. to 140° C., still more preferably in the range of from 127° C. to 137° C. and most preferably in the range of from 130° C. to 135° C.

A further feature of the propylene polymer composition is the dependency of the melting temperature on the comonomer content within the terpolymer of propylene. It is known that with increase of comonomer the melting temperature decreases. However to obtain the desired properties of the present invention the melting temperature and the comonomer content must comply a specific relationship. Thus it is preferred that the numerical values of the melting temperature and the comonomer content of propylene polymer composition (given in ° C. and wt % respectively) according to the instant invention fulfills the equation (1), more preferably the equation (1a), yet more preferably the equation (1b),

Tm≥160−α×5.25 (1)

Tm≥161−α×5.25 (1a)

Tm≥162−α×5.25 (1b)

wherein
Tm is the numerical value of the melting temperature [measured in ° C.] of said propylene polymer composition measured according to ISO 11357-3,
α is the numerical value of the amount [measured in weight percentage] of comonomers, i.e. of ethylene (C2) and the alpha-olefin (C4-12) together, within said terpolymer determined ¹³C nuclear magnetic resonance spectroscopy (¹³C-NMR).

Further it is appreciated that the propylene polymer composition has a crystallization temperature Tc measured according to ISO 11357-3 of equal or below than 115° C., more preferably equal or below 110° C., still more preferably in the range 95 to 115° C., like in the range of 100 to 110° C.

Further it is appreciated that the propylene polymer composition has a rather narrow molecular weight distribution (MWD). Accordingly the propylene polymer composition has a molecular weight distribution (MWD) measured by size exclusion chromatography (SEC) according to ISO 16014 of not more than 6.0, more preferably not more than 5.0, yet more preferably not more than 4.5, still more preferably in the range of 2.0 to 6.0, still yet more preferably in the range of 2.2 to 4.5.

Further it is appreciated that the xylene cold soluble content (XCS) measured according to ISO 16152 (25° C.) of the propylene polymer composition is not more than 12.0 wt-%, more preferably of not more than 10.0 wt.-%, yet more preferably of not more than 9.5 wt.-%, like not more than 9.0 wt.-%. Thus a preferred range is 1.0 to 12.0 wt.-%, more preferred 2.0 to 10.0 wt.-%, still more preferred 2.5 to 9.0 wt.-%.

### Melt Spun Fibers

The propylene polymer composition is spun into melt spun fibers using a suitable spinning line as known in the art.

Melt spun fibers differ essentially from other fibres, in particular from those produced by melt blown processes.

A typical melt-spinning process consists of a continuous filament extrusion, followed by drawing.

First, pellets or granules of the terpolymer of propylene as defined above or below are fed into an extruder. In the extruder, the pellets or granules are melted and forced through the system by a heating melting screw. At the end of the screw, a spinning pump meters the molten polymer through a filter to a spinneret where the molten polymer is extruded under pressure through capillaries, at a rate of 0.3 to 1.0 grams per hole per minute. The spinneret contains between 65 and 75 holes per cm, measuring 0.4 mm to 0.7 mm in diameter. The terpolymer of propylene is melted at about 30° C. to 150° C. above its melting point to achieve sufficiently low melt viscosity for extrusion. The fibers exiting the spinneret are quenched and drawn into fine fibers measuring at most 20 microns in diameter by cold air jets, reaching filament speeds of at least 2 500 m/min.

Preferably, the melt spun fibers have an average filament fineness of not more than 2.0 denier and more preferably of not more than 1.9 denier.

Additionally or alternatively, the melt spun fibers have an average filament fineness in the range of 1.0 denier to 2.0 denier and more preferably in the range of 1.2 denier to 1.9 denier.

The melt spun fibers are suitable for producing spunbonded fabrics in the form of nonwoven fabrics.

The melt spun fiber of the present invention preferably can be spun at a maximum take-up speed at a constant throughput of 2 kg/h of more than 4000 m/min, such as at least 4050 m/min, more preferably at least 4100 m/min and most preferably at least 4150 m/min.

The upper limit of the maximum take-up speed at a constant throughput of 2 kg/h is usually not higher than 10000 m/min, preferably not higher than 7500 m/min.

The melt spun fiber of the present invention preferably further preferably has a tenacity of more than 2.0 cN/Dtex at a take-up speed of 1000 m/min, such as at least 2.1 cN/Dtex, more preferably of at least 2.2 cN/Dtex and most preferably of at least 2.3 cN/Dtex.

The upper limit of the tenacity at a take-up speed of 1000 m/min is usually not higher than 10.0 cN/Dtex, preferably not higher than 5.0 cN/Dtex.

Further, the melt spun fiber of the present invention preferably further preferably has a tenacity of more than 3.0 cN/Dtex at a take-up speed of 4000 m/min, such as at least 3.1 cN/Dtex, more preferably of at least 3.15 cN/Dtex and most preferably of at least 3.2 cN/Dtex.

The upper limit of the tenacity at a take-up speed of 4000 m/min is usually not higher than 10.0 cN/Dtex, preferably not higher than 7.5 cN/Dtex.

Still further, melt spun fiber of the present invention preferably further preferably has an elongation of not more than 250% at a take-up speed of 1000 m/min, such as not more than 235%, more preferably of not more than 220% and most preferably of not more than 200%.

The lower limit of the elongation at a take-up speed of 1000 m/min is usually at least 50%, preferably at least 75%.

Still further, melt spun fiber of the present invention preferably further preferably has an elongation of not more than 125% at a take-up speed of 4000 m/min, such as not more than 110%, more preferably of not more than 100% and most preferably of not more than 90%.

The lower limit of the elongation at a take-up speed of 1000 m/min is usually at least 25%, preferably at least 50%.

The melt spun fibers according to the invention can be mono-component melt spun fibers or multi-component melt spun fibers, such as bi-component melt spun fibers.

### Spunbonded Nonwoven Fabric

In another aspect the present invention relates to a spunbonded nonwoven fabric comprising the melt spun fibers as described above or below.

Spunbonded fibres differ essentially from other fibres, in particular from those produced by melt blown processes.

A particular aspect of the present invention refers to a process for the preparation of a spunbonded nonwoven fabric comprising the steps of

providing a propylene polymer composition comprising a terpolymer of propylene with ethylene comonomer units and alpha-olefin comonomer units having from 4 to 12 carbon atoms, which has a melt flow rate MFR (230° C., 2.16 kg) of from 10 to 200 g/10 min and a melting temperature of less than 153° C.; and

spunbonding said propylene polymer composition by using a fiber spinning line at a maximum cabin air pressure of from 3,000 Pa to 10,000 Pa.

The cabin air pressure can be at least 4,000 Pa and more preferably 5,000 Pa. The cabin air pressure can be up to 9 000 Pa.

Suitably, the terpolymer of propylene with ethylene comonomer units and alpha-olefin comonomer units having from 4 to 12 carbon atoms and the propylene polymer composition are as defined above or below.

The spun bonding process is one which is well known in the art of fabric production. In general, continuous fibers are extruded, laid on an endless belt, and then bonded to each other, and often times to a second layer such as a melt blown layer, often by a heated calander roll, or addition of a binder, or by a mechanical bonding system (entanglement) using needles or hydro jets.

A typical spunbonded process consists of a continuous filament extrusion, followed by drawing, web formation by the use of some type of ejector, and bonding of the web. First, pellets or granules of the terpolymer of propylene as defined above or below are fed into an extruder. In the extruder, the pellets or granules are melted and forced through the system by a heating melting screw. At the end of the screw, a spinning pump meters the molten polymer through a filter to a spinneret where the molten polymer is extruded under pressure through capillaries, at a rate of 0.3 to 1.0 grams per hole per minute. The spinneret contains between 65 and 75 holes per cm, measuring 0.4 mm to 0.7 mm in diameter. The terpolymer of propylene is melted at about 30° C. to 150° C. above its melting point to achieve sufficiently low melt viscosity for extrusion. The fibers exiting the spinneret are quenched and drawn into fine fibers measuring at most 20 microns in diameter by cold air jets, reaching filament speeds of at least 2 500 m/min. The solidified fiber is laid randomly on a moving belt to form a random netlike structure known in the art as web. After web formation the web is bonded to achieve its final strength using a heated textile calander known in the art as thermobonding calander. The calander consists of two heated steel rolls; one roll is plain and the other bears a pattern of raised points. The web is conveyed to the calander wherein a fabric is formed by pressing the web between the rolls at a bonding temperature of about 90° C. to 140° C. The resulting webs preferably have an area weight of 3 to 100 g/m², more preferably of 5 to 50 g/m².

Preferably, the spunbonded nonwoven fabric according to the present invention can be calandered at a low bonding or calander temperature of 90 to 140° C., more preferably of 100 to 130° C. and most preferably of 105 to 125° C.

Spunbonded nonwoven fabrics according to the present invention show excellent tensile properties.

More specifically, said spunbonded nonwoven fabrics are preferably characterized by an advantageous relation between tensile strength (TS) and elongation at break (EB) like

EB(CD)>64+1.1*TS(CD)−0.011*TS(CD)²

Both parameters being determined in cross direction (CD), i.e. perpendicular to processing direction on spunbonded nonwoven fabrics having an area weight in the range of 5 to 50 g/m² in accordance with EN 29073-3 (1989).

Thereby, the spunbonded nonwoven fabric preferably have a tensile strength in machine direction (TS-MD) of from 25 N/5 cm to 65 N/5 cm, more preferably of from 35 N/5 cm to 60 N/5 cm and most preferably of from 40 N/5 cm to 50 N/5 cm.

Further, the spunbonded nonwoven fabric preferably have a tensile strength in cross direction (TS-CD) of from 15 N/5 cm to 50 N/5 cm, more preferably of from 20 N/5 cm to 45 N/5 cm and most preferably of from 25 N/5 cm to 40 N/5 cm.

Additionally, the spunbonded nonwoven fabric preferably have elongation at break in machine direction (EB-MD) of from 70% to 150%, more preferably of from 75% to 135% and most preferably of from 80% to 120%.

Further, the spunbonded nonwoven fabric preferably have elongation at break in cross direction (EB-CD) of from 70% to 150%, more preferably of from 75% to 135% and most preferably of from 80% to 120%.

### Article

The present invention is further directed to articles, like webs, made from the melt spun fibers and/or spunbonded nonwoven fabric as described above or below. Accordingly, the present invention is directed to articles comprising the melt spun fibers and/or spunbonded fabric of the present invention, like filtration medium (filter), diaper, sanitary napkin, panty liner, incontinence product for adults, protective clothing, surgical drape, surgical gown, and surgical wear.

The articles of the present invention may comprise in addition to the spunbonded fabric a melt blown web known in the art.

### Use

Further, the present invention relates to the use of a terpolymer of propylene with ethylene comonomer units and alpha-olefin comonomer units having from 4 to 12 carbon atoms in a propylene polymer composition having a melt flow rate MFR (230° C., 2.16 kg) of from 10 to 200 g/10 min and a melting temperature of less than 153° C. for increasing the spinnability of melt spun fibers.

Still further, the present invention relates to the use of a terpolymer of propylene with ethylene comonomer units and alpha-olefin comonomer units having from 4 to 12 carbon atoms in a propylene polymer composition having a melt flow rate MFR (230° C., 2.16 kg) of from 10 to 200 g/10 min and a melting temperature of less than 153° C. for increasing the mechanical properties of spunbonded nonwoven fabrics.

Suitably, the terpolymer of propylene with ethylene comonomer units and alpha-olefin comonomer units having from 4 to 12 carbon atoms, the propylene polymer composition, the melt spun fibers and the spunbonded nonwoven fabrics are as defined above or below.

### Examples

### a) Determination Methods

MFR₂ (230° C.) is measured according to ISO 1133 (230° C., 2.16 kg load). The MFR₂ of the polypropylene composition is determined on the granules of the material, while the MFR₂ of the melt-blown web is determined on cut pieces of a compression-molded plaque prepared from the web in a heated press at a temperature of not more than 200° C., said pieces having a dimension which is comparable to the granule dimension.

The xylene soluble fraction at room temperature (xylene cold soluble XCS, wt %): The amount of the polymer soluble in xylene is determined at 25° C. according to ISO 16152; 5th edition; 2005 Jul. 1.

### Comonomer Content Determination

Quantitative nuclear-magnetic resonance (NMR) spectroscopy was used to quantify the comonomer content of the polymers.

Quantitative ¹³C {¹H} NMR spectra recorded in the molten-state using a Bruker Advance III 500 NMR spectrometer operating at 500.13 and 125.76 MHz for ¹H and ¹³C respectively. All spectra were recorded using a ¹³C optimised 7 mm magic-angle spinning (MAS) probehead at 180° C. using nitrogen gas for all pneumatics. Approximately 200 mg of material was packed into a 7 mm outer diameter zirconia MAS rotor and spun at 4.5 kHz. This setup was chosen primarily for the high sensitivity needed for rapid identification and accurate quantification. {klimke06, parkinson07, castignolles09} Standard single-pulse excitation was employed utilising the NOE at short recycle delays {pollard04, klimke06} and the RS-HEPT decoupling scheme {fillip05,griffin07}. A total of 1024 (1 k) transients were acquired per spectra.

Quantitative ¹³C{¹H} NMR spectra were processed, integrated and relevant quantitative properties determined from the integrals. All chemical shifts are internally referenced to the methyl isotactic pentad (mmmm) at 21.85 ppm.

Characteristic signals corresponding to regio defects were not observed {resconi00}. The amount of propene was quantified based on the bulk Pββ methyl sites at 21.9 ppm:

Ptotal=I_{Pββ}

Characteristic signals corresponding to the incorporation of 1-butene were observed and the comonomer content quantified in the following way: The amount isolated 1-butene incorporated in PPBPP sequences was quantified using the integral of the αB2 sites at 44.1 ppm accounting for the number of reporting sites per comonomer:

B=I_{αB2}/2

The amount consecutively incorporated 1-butene in PPBBPP sequences was quantified using the integral of the ααB2 site at 40.5 ppm accounting for the number of reporting sites per comonomer:

BB=2*I_{αα}B2

The total 1-butene content was calculated based on the sum of isolated and consecutively incorporated 1-butene:

Btotal=B+BB

The mole fraction of 1-butene in the polymer was calculated with respect to all monomers present in the polymer:

fBtotal=(Btotal/(Etotal+Ptotal+Btotal)

Characteristic signals corresponding to the incorporation of ethylene were observed and the comonomer content quantified in the following way: The amount isolated ethylene incorporated in PPEPP sequences was quantified using the integral of the Sαγ sites at 37.9 ppm accounting for the number of reporting sites per comonomer:

E=I_{Sαγ}/2

With no sites indicative of consecutive incorporation observed the total ethylene comonomer content was calculated solely on this quantity:

Etotal=E

Characteristic signals corresponding to other forms of ethylene incorporation such as consecutive incorporation were not observed.

The mole percent comonomer incorporation was calculated from the mole fractions:

B [mol %]=100*fB

E [mol %]=100*fE

The weight percent comonomer incorporation was calculated from the mole fractions:

B [wt %]=100*(fB*56.11)/((fE*28.05)+(fB*56.11)+((1−(fE+fB))*42.08))

E [wt %]=100*(fE*28.05)/((fE*28.05)+(fB*56.11)+((1−(fE+fB))*42.08))

### CITATIONS

klimke06—Klimke, K., Parkinson, M., Piel, C., Kaminsky, W., Spiess, H. W., Wilhelm, M., Macromol. Chem. Phys. 207 (2006) 382
parkinson07—Parkinson, M., Klimke, K., Spiess, H. W., Wilhelm, M., Macromol. Chem. Phys. 208 (2007) 2128
pollard04—Pollard, M., Klimke, K., Graf, R., Spiess, H. W., Wilhelm, M., Sperber, O., Piel, C., Kaminsky, W., Macromolecules 37 (2004) 813
castignolles09—Castignolles, P., Graf, R., Parkinson, M., Wilhelm, M., Gaborieau, M., Polymer 50 (2009) 2373
resconi00—Resconi, L., Cavallo, L., Fait, A., Piemontesi, F., Chem. Rev. 100 (2000) 1253

DSC analysis, melting temperature (Tₘ), melting enthalpy (Hₘ), crystallization temperature (T_{c}) and crystallization enthalpy (H_{c}): measured with a TA Instrument Q200 differential scanning calorimetry (DSC) on 5 to 7 mg samples. DSC is run according to ISO 11357-1, -2 and -3/method C2 in a heat/cool/heat cycle with a scan rate of 10° C./min in the temperature range of −30 to +225° C. Crystallization temperature (T_{c}) and crystallization enthalpy (H_{c}) are determined from the cooling step, while melting temperature (Tₘ) and melting enthalpy (Hₘ) are determined from the second heating step respectively from the first heating step in case of the webs.

Number Average Molecular Weight (Mₙ), Weight Average Molecular Weight (M_{w}), (M_{w}/Mₙ=MWD) of Propylene Homopolymer

Molecular weight averages Mw, Mn and MWD were determined by Gel Permeation Chromatography (GPC) according to ISO 16014-4:2003 and ASTM D 6474-99. A PolymerChar GPC instrument, equipped with infrared (IR) detector was used with 3× Olexis and 1× Olexis Guard columns from Polymer Laboratories and 1,2,4-trichlorobenzene (TCB, stabilized with 250 mg/L 2,6-Di tert butyl-4-methyl-phenol) as solvent at 160° C. and at a constant flow rate of 1 mL/min. 200 μL of sample solution were injected per analysis. The column set was calibrated using universal calibration (according to ISO 16014-2:2003) with at least 15 narrow MWD polystyrene (PS) standards in the range of 0.5 kg/mol to 11 500 kg/mol. Mark Houwink constants for PS, PE and PP used are as described per ASTM D 6474-99. All samples were prepared by dissolving the polymer sample to achieve concentration of ˜1 mg/ml (at 160° C.) in stabilized TCB (same as mobile phase) for 2.5 hours for PP at max. 160° C. under continuous gently shaking in the autosampler of the GPC instrument. The MWD of the polypropylene composition is determined on the granules of the material, while the MWD of the melt-blown web is determined on a fiber sample from the web, both being dissolved in an analogous way.

### Mechanical Properties of the Web

The mechanical properties of the webs were determined in accordance with EN 29073-3 (1989) “Test methods for nonwovens—Determination of tensile strength and elongation”

### Method for Tenacity and Elongation in the High Speed Spinning Test

The mechanical properties of the fibres have been determined by using a statimat (automatic type—chargeable up to 20 bobbins) according ISO 2062.

### b) Examples

The commercial propylene/ethylene/1-butene terpolymer TD220BF, commercially available from Borealis AG, as listed in Table 1 below, has been used as base polymer for visbreaking for inventive example IE1. This polymer is based on a conventional Ziegler-Natta catalyst and produced in a loop/gas phase polymerization plant. The properties of the visbroken polymer of IE1 are listed in Table 2.

The commercial propylene homopolymer HG420FB, commercially available from Borealis AG as listed in Table 2 below has been used as base polymer for inventive example CE2. This polymer is based on a 4^{th} generation Ziegler-Natta catalyst and produced in a Spheripol polymerization plant. HG420FB has been subjected to visbreaking. The properties of the visbroken polymer of CE2 are listed in Table 2.

Both polymer used were the commercially available pellets addivated with a standard additive package.

TABLE 1
Properties of the non-visbroken terpolymer

| Base polymer | | Terpolymer |
|---|---|---|
| MFR₂ | [g/10 min] | 6.0 |
| C₂ | [wt %] | 1.7 |
| C₄ | [wt %] | 6.5 |
| Tₘ | [° C.] | 132 |

C₂ = ethylene content
C₄ = 1-butene content

The terpolymer and the homopolymer were visbroken by using a co-rotating twin extruder at 200-230° C. and using an appropriate amount of (tert-butylperoxy)-2,5-dimethylhexane (Trigonox 101, commercially available from Akzo Nobel, Netherlands) to achieve the target MFR₂ of 25 g/10 min. Table 2 shows the properties of the visbroken terpolymer of inventive example IE1 and the visbroken homopolymer of comparative example CE2.

TABLE 2
Properties of visbroken polymers of examples IE1 and CE2

| Base polymer | | IE1 | CE2 |
|---|---|---|---|
| MFR₂ | [g/10 min] | 25 | 25 |
| C₂ | [wt %] | 1.7 | 0 |
| C₄ | [wt %] | 6.5 | 0 |
| Tₘ | [° C. | 132 | 161 |

### c) High Speed Spinning Tests

The compositions of inventive example IE1 and comparative example CE2 were melt spun using a Fourné high speed spinning line using a spinnerette with 2.52 holes with a diameter d of 0.5 mm and a ratio L/d of 2.

The fiber was quenched in a quenching bath at a temperature of 17° C. and a guide roll speed of 0.3 m/s.

In the high speed test the maximum teak-up speed was measured at constant throughput. The task was to determine the maximum speed that can be maintained without filament breaks.

The throughput per hole has been kept constant at 0.32 g/(hole·min) at a total throughput of 2 kg/h.

The take-up speed was controlled via the speed of the take up roll. The melt temperature was set to 235° C.

The test was started at a take-up speed of 1000 m/min.

Inventive example IE1 showed a maximum take-up speed of 4200 m/min whereas comparative example CE2 showed a maximum take-up speed of 4000 m/min.

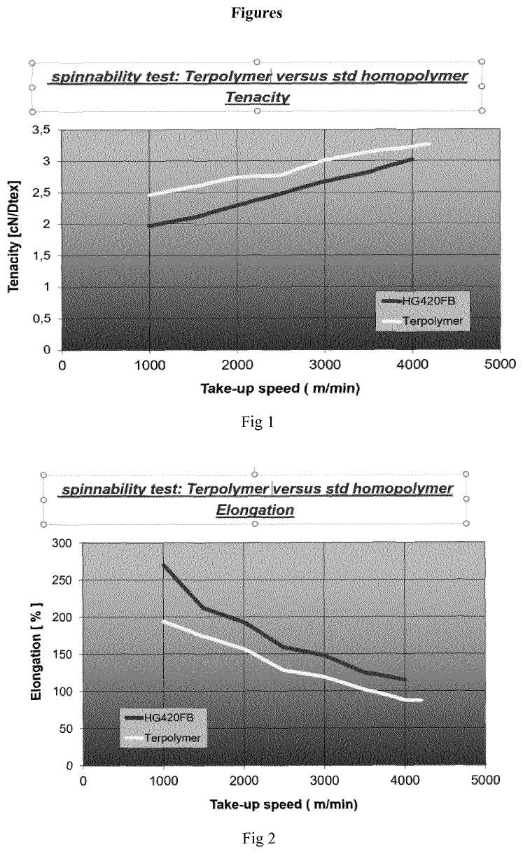

FIG. 1 shows a comparison of the tenacity behavior of the fibers of the inventive example IE1 and of the comparative example CE2 over a take-up speed range from the starting take-up speed of 1000 m/min to their maximum take-up speeds of 4200 m/min and 4000 m/min, respectively.

Over the whole take-up speed range the fibers of inventive example show a higher tenacity compared to the fibers of the comparative example CE2.

FIG. 2 shows a comparison of the elongation of the fibers of the inventive example IE1 and of the comparative example CE2 over a take-up speed range from the starting take-up speed of 1000 m/min to their maximum take-up speeds of 4200 m/min and 4000 m/min, respectively.

Over the whole take-up speed range the fibers of inventive example show a lower elongation compared to the fibers of the comparative example CE2.

### d) Properties of the Spunbonded Non-Woven Fabrics

In a second experiment the compositions of inventive example IE1 and comparative example CE2 were converted into spunbonded fabrics on a 1 m single beam Reicofil 3 spunbonded pilot line.

The throughput was kept constant at 156 kg/h and the produced fabrics had a weight of 17 g/m².

Table 3 summarizes the mechanical properties and processability of the spunbonded fabrics of examples IE1 and CE2.

TABLE 3
Mechanical properties and processability of the
spunbonded fabrics of examples IE1 and CE2

| | | IE1 | CE2 |
|---|---|---|---|
| Minimum titre | [den] | 1.7 | 1.8 |
| Max. Tensile strength MD | [N/5 cm] | 44.1 | 47.7 |
| Elongation MD | [%] | 85.5 | 69.0 |
| Max. Tensile strength CD | [N/5 cm] | 26.2 | 23.9 |
| Elongation CD | [%] | 91.5 | 70.0 |
| Calander Temperature | [° C.] | 114 | 147 |

From the results above it can be seen that the inventive example IE1 shows excellent spinning properties combined with good mechanical properties and an extreme low bonding temperature.

1. A melt spun fiber comprising a propylene polymer composition comprising a terpolymer of propylene with ethylene comonomer units and alpha-olefin comonomer units having from 4 to 12 carbon atoms,
wherein the propylene polymer composition has a melt flow rate MFR (230° C., 2.16 kg) of from 10 to 200 g/10 min and a melting temperature measured according to ISO 11357-3 of less than 153° C.

2. The melt spun fiber according to claim 1, wherein the terpolymer of propylene with ethylene comonomer units and alpha-olefin comonomer units having from 4 to 12 carbon atoms has from 0.3 to 5.0 wt % of ethylene comonomer units and from 2.0 to 10 wt % of alpha-olefin comonomer units having from 4 to 12 carbon atoms, based on the total weight of the terpolymer of propylene with ethylene comonomer units and alpha-olefin comonomer units having from 4 to 12 carbon atoms.

3. The melt spun fiber according to claim 1, wherein the weight ratio of ethylene comonomer units (C2) to alpha-olefin comonomer units having from 4 to 12 carbon atoms (C4-20) [C2/C4-20] in the terpolymer of propylene with ethylene comonomer units and alpha-olefin comonomer units having from 4 to 12 carbon atoms is in the range of 1/6 to 1/2.5.

4. The melt spun fiber according to claim 1, wherein the terpolymer of propylene with ethylene comonomer units and alpha-olefin comonomer units having from 4 to 12 carbon atoms is a terpolymer of propylene with ethylene comonomer units and 1-butene comonomer units.

5. The melt spun fiber according to claim 1 having a maximum take-up speed at a constant throughput of 2 kg/h of more than 4000 m/min.

6. The melt spun fiber according to claim 1 having a tenacity of more than 2 cN/Dtex at a take-up speed of 1000 m/min and a tenacity of more than 3 cN/Dtex at a take-up speed of 4000 m/min.

7. The melt spun fiber according to claim 1 having an elongation of not more than 250% at a take-up speed of 1000 m/min and an elongation of not more than 125% at a take-up speed of 4000 m/min.

8. A spunbonded nonwoven fabric comprising the melt spun fibers according to claim 1.

9. The spunbonded nonwoven fabric according to claim 8 having a tensile strength in machine direction (TS-MD) of from 25 to 65 N/5 cm and a tensile strength in cross direction (TS-CD) of from 15 to 50 N/5 cm.

10. The spunbonded nonwoven fabric according to claim 8 having elongation at break in machine direction (EB-MD) of from 70 to 150% and elongation at break in cross direction (EB-CD) of from 70 to 150%.

11. The spunbonded nonwoven fabric according to claim 8 meeting the following relation
EB-CD>64+1.1·TS-CD−0.011·(TS-CD)²,
wherein
EB-CD refers to the elongation at break in cross direction, and
TS-CD refers to the tensile strength in cross direction.

12. A process for preparing a spunbonded nonwoven fabric according to claim 8 comprising the steps of
providing a propylene polymer composition comprising a terpolymer of propylene with ethylene comonomer units and alpha-olefin comonomer units having from 4 to 12 carbon atoms, which has a melt flow rate MFR (230° C., 2.16 kg) of from 10 to 200 g/10 min and a melting temperature measured according to ISO 11357-3 of less than 153° C.; and
spunbonding said propylene polymer composition by using a fiber spinning line at a maximum cabin air pressure of from 3,000 Pa to 10,000 Pa.

13. An article comprising the melt spun fiber according to claim 1 or the spunbonded nonwoven fabric according to claim 8.

14. The article according to claim 13 being selected from filtration medium, diaper, sanitary napkin, panty liner, incontinence product for adults, protective clothing, surgical drape, surgical gown, and surgical wear.

15. (canceled)

16. (canceled)
